(19) United States
(12) Patent Application Publication
(10) Pub. No.: US 2020/0065630 A1
(43) Pub. Date: Feb. 27, 2020

(54) AUTOMATED EARLY ANOMALY DETECTION IN A CONTINUOUS LEARNING MODEL

(71) Applicant: International Business Machines Corporation, Armonk, NY (US)

(72) Inventors: Lucas G. Cmielowski, Krakow (PL); Wojciech Sobala, Krakow (PL); Umit M. Cakmak, Krakow (PL); Marek Oszajec, Debica (PL)

(21) Appl. No.: 16/107,557

(22) Filed: Aug. 21, 2018

(51) Int. Cl. G06K 9/62; G06F 15/18

(52) U.S. Cl. CPC G06K 9/6263; G06K 9/6256; G06F 15/18

(57) ABSTRACT

Embodiments of the present invention provide a method, system and computer program product for automated early anomaly detection in a continuous learning model. In an embodiment of the invention, a method includes training a continuous learning model with a training data set of different records and a known target class for each of the different records, deploying the model, and monitoring performance of the model. The method further includes prior to receiving a complete feedback data set for the model, computing a metric in the model based upon unseen records in the model that had not been present in the training data set, determining poor quality of the model for a metric computed to exceed a threshold value and displaying a recommendation in the host server to retrain the model responsive to the determination of poor quality of the model.

### BACKGROUND OF THE INVENTION

### Field of the Invention

The present invention relates to the field of machine learning models and more particularly to continuous learning systems.

### Description of the Related Art

A continuous learning system is a machine learning model that is continuously maintained with updated data, which allows for automated life cycle management of the machine learning model. Normally, a continuous learning system operates by monitoring deployed model quality and retraining the model when the quality of the predicted output is below a specified threshold. After the model has been retrained, the model is redeployed and the accuracy is tested once again to determine whether the accuracy of the newly trained model exceeds the accuracy of the previously trained model.

In order to determine the accuracy of the model, feedback data—that is, data not used in the training of the model—is provided by the user to compare the predicted output of the model to the actual output contained in the feedback data. Feedback data includes data that was purposely not included in the training data set to test the model, as well as newly procured data that may not have been available beforehand. As feedback data takes time to procure and clean prior to the use of the feedback data in testing and eventually retraining the model, oftentimes models are not tested and retrained on the most current set of data. Furthermore, the end user must often wait until enough new feedback data is obtained in order to have a large enough data set to accurately test and retrain the model.

As such, currently the choice as to when to test and retrain a model based on newly obtained feedback data is a subjective choice left to the end user. Therefore, in order to fully automate a continuous learning system, a more objective approach is required to optimize the testing and retraining of the continuous learning system based on updated feedback data.

### BRIEF SUMMARY OF THE INVENTION

Embodiments of the present invention address deficiencies of the art in respect to learning models and provide a novel and non-obvious method, system and computer program product for automated early anomaly detection in a continuous learning model. In an embodiment of the invention, a method for automated early anomaly detection in a continuous learning model includes training a continuous learning model with a training data set of different records and a known target class for each of the different records, deploying the continuous learning model in memory of a host server, and monitoring performance of the continuous learning model. The method further includes prior to receiving a complete feedback data set for the continuous learning model, computing a metric in the continuous learning model based upon unseen records in the continuous learning model that had not been present in the training data set, determining poor quality of the continuous learning model for a metric computed to exceed a threshold value and displaying a recommendation in the host server to retrain the continuous learning model responsive to the determination of poor quality of the continuous learning model.

In one aspect of the embodiment, the metric is computed based upon a number of unseen records in the continuous learning model relative to a total number of records in the continuous learning model. In another aspect of the embodiment, the metric is computed based upon a number of unique ones of the unseen records in the continuous learning model relative to the number of unseen records in the continuous learning model relative to the total number of records in the continuous learning model. In yet another aspect of the embodiment, the metric is a combination of the number of unseen records in the continuous learning model relative to the total number of records in the continuous learning model and the number of unique ones of the unseen records in the continuous learning model relative to the number of unseen records in the continuous learning model. In even yet another aspect of the embodiment, each of the number of unseen records in the continuous learning model relative to the total number of records in the continuous learning model, and the number of unique ones of the unseen records in the continuous learning model relative to the number of unseen records in the continuous learning model are weighted within the combination.

In another embodiment of the invention, a data processing system is configured for automated early anomaly detection in a learning model. The system includes a host computing system that includes memory and at least one processor, fixed storage coupled to the host computing system, and an automated early anomaly detection module. The module includes computer program instructions executing in the memory of the host computing system that upon execution are adapted to perform: training a continuous learning model with a training data set of different records and a known target class for each of the different records, deploying the continuous learning model in the memory of the host computing system, and monitoring performance of the continuous learning model. The program instruction are further adapted to perform: prior to receiving a complete feedback data set for the continuous learning model, computing a metric in the continuous learning model based upon unseen records in the continuous learning model that had not been present in the training data set, determining poor quality of the continuous learning model for a metric computed to exceed a threshold value and displaying a recommendation in the host server to retrain the continuous learning model responsive to the determination of poor quality of the continuous learning model.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for automated early anomaly detection in a continuous learning model;

FIG. 2 is a schematic illustration of a data processing system adapted for automated early anomaly detection in a continuous learning model; and,

FIG. 3 is a flow chart illustrating a process for automated early anomaly detection in a continuous learning model.

### DETAILED DESCRIPTION OF THE INVENTION

Embodiments of the invention provide for the automated early anomaly detection in a continuous learning model prior to the receipt of a complete feedback data set for the continuous learning model. In accordance with an embodiment of the invention, a continuous learning model is trained utilizing a training data set of known records. Once trained, the continuous learning model is deployed into a computing system and monitored during deployment. Thereafter, the collection of a feedback data set commences, but before a complete feedback data set is received, an evaluation of the quality of the continuous learning model is determined by computing a metric based upon a number of unseen records in the collected feedback data set. To the extent that the metric exceeds a threshold value, a recommendation to retrain the continuous learning model may be displayed in the computing system even though a complete feedback data set is yet to be received.

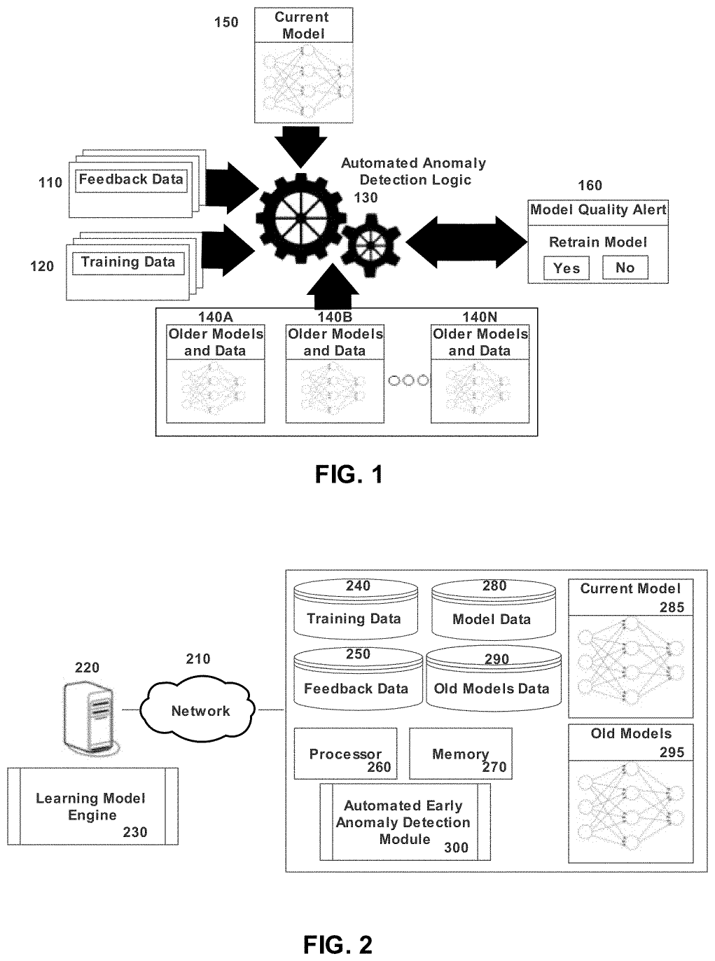

In further illustration, FIG. 1 pictorially shows a process for automated early anomaly detection in a learning model. As shown in FIG. 1, a training data set of known records 120 to train a continuous learning model is input into automated anomaly detection logic 130. Furthermore, the trained continuous learning model is deployed and monitored by automated anomaly detection logic 130. As well, a feedback data set, as the feedback data set is collected, is input into automated anomaly detection logic 130. The training data set 120 and the incomplete feedback data set 110 are each made up of a plurality of records. The records may be organized by specific features, specific known target classes or the records may be unorganized.

Based on the requirements of the learning model, certain records of certain features in the training data 120 may not be used by the learning model in order to produce the output. However, updated learning models may later include the records of these features or target classes based on newly discovered information or a change in the parameters of the learning model. Therefore, not only are there records unseen by the learning model in the feedback data 110, there may also be records that are unseen by the learning model in the training data 120. The training data 120 and feedback data 110 may also contain records that are not unique, such as records overlapping between the feedback data and training data, as well multiple records of the same data in each of the feedback data 110, training data 120, or a combination of the two data sets.

The automated anomaly detection logic 130 compares the feedback data 110, as it is collected, and training data 120 to calculate a metric for determining poor quality of the model based on the number of unseen records that had not been present in the training data set 120. Automated anomaly detection logic 130 may also determine a total number of records in the data sets, a total number of records that were unseen or not used to train the model, a total number of unique records that are not repeated in the data sets and a total number or unique records that were unseen or not used to train the model. The automated anomaly detection logic 130 may then compute a ratio of records by dividing the total number of unseen records by a total number of records and a ratio of unique records by dividing a total number of unique unseen records by a total number of unique records. The metric for determining poor quality of the model may be based on any combination of these numbers and ratios.

The automated anomaly detection logic 130 may also weight the ratios by their respective weights and sum the weighted ratios to compute the metric for determining poor quality of the model. The automated anomaly detection logic 130 then determines if the metric exceeds a determined threshold value. If the metric exceeds the threshold, a recommendation 160 to retrain the continuous learning model is displayed to the end user. Alternatively, if the metric exceeds the threshold, the automated anomaly detection logic 130 may automatically retrain the model with the feedback data, the training data, or some combination of the two data sets.

The current continuous model data 150, with its respective accuracy determined by previously input completed feedback sets, as well older model data 140A and 140B are input into the automated anomaly detection logic 130. In this way, the automated anomaly detection logic 130 can compare the accuracy of previous models 140A and 140B and the current model 150 to determine whether the current model 150 exceeds the accuracy of previous models 140A and 140B. Furthermore, the automated anomaly detection logic 130 can use an iterative feedback process to determine the most efficient weights of the ratios and the threshold level, so as to produce the most accurate model taking into account any computing power limitations.

The process shown in FIG. 1 may be implemented in a computer data processing system. In further illustration, FIG. 2 schematically shows a data processing system adapted for automated early anomaly detection in a learning model. The system 200 communicates over a network 210 with a server 220 that houses a learning model engine 230. The system 200 includes at least one processor 260 and memory 270 and fixed storage disposed within the system. The fixed storage stores the training data 240, feedback data 250, data from the new or current model 280, new or current model 285, data from the old models 290, the old models 295, and an automated early anomaly detection module 300.

The automated early anomaly detection module 300 compares the training data 240 used to train the current model 285 to the feedback data 250, as it is collected, not used to train the current model 285. Prior to receiving he complete feedback set, the automated early anomaly detection module 300 computes a metric based upon unseen records in the feedback set to determine whether the quality of the continuous learning model is poor. The automated early anomaly detection module 300 may also compute the metric by comparing the data sets to determine a total number of records in the data sets, a total number of records that were unseen or not used to train the model, a total number of unique records that are not repeated in the data sets and a total number or unique records that were unseen or not used to train the model.

The automated early anomaly detection module 300 then may compute the metric by determining a ratio of records by dividing total number of unseen records by a total number of records and a ratio of unique records by dividing a total number of unique unseen records by a total number of unique records and summing the ratios. The automated early anomaly detection module 300 may also compute the metric by multiplying the ratios by their respective weights and compute a sum of the weighted ratios. The automated anomaly detection logic 130 then determines if the metric exceeds a determined threshold value. The system displays a recommendation to alert the end user to retrain the model or by automatically retraining the model if the metric exceeds the threshold. The model is then retrained with the feedback data 250 and the training data 240 by sending the data over the network 210 to the learning model engine 230.

In order to optimize the threshold value and weights of the ratios, the values are determined through an iterative feedback process, similar to how the output of the learning model is determined, through the learning model engine 230. The data of the old models 290 and the data of the current model 280, more specifically their respective accuracies, feedback data, training data, ratios, ratio weights and threshold values are fed through iterative feedback process of the learning model engine 230. Thus, the values of the weights of the ratios and the threshold value are tuned to trigger an alert or the retraining process in order to optimize the accuracy of the newly retrained model, as limited by the internal computing power of the system.

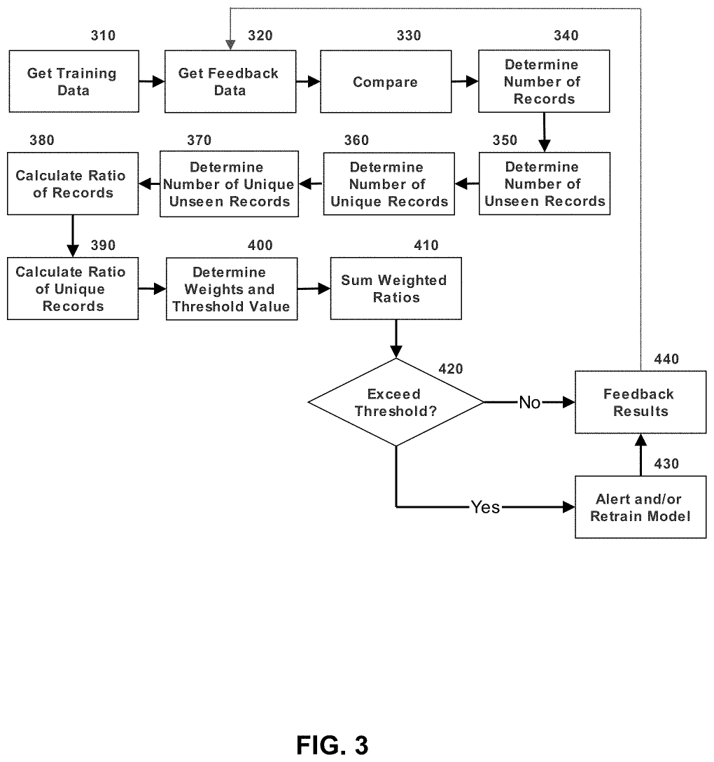

In even yet further illustration of the operation of the automated early anomaly detection module 300, FIG. 3 is a flow chart illustrating an exemplary process for automated early anomaly detection in a learning model. Beginning in block 310, the training data is received and in block 320 the incomplete feedback data is received. In block 330, the records of the feedback data and the records of the training data are compared in order to determine (1) a total number of records in block 340; (2) a total number of unseen records in block 350; (3) a total number of unique records in block 360; and (4) a total number of unique unseen records in block 370. In block 380, the ratio of records is computed by dividing total number of unseen records by a total number of records and, in block 390, the ratio of unique records is computed by dividing a total number of unique unseen records by a total number of unique records.

In block 400, weights of the ratios and the threshold value are determined. In block 410, the ratios are multiplied by their respective weights and the weighted ratios are summed. In block 420, if the value of the sum exceeds the determined threshold, an indication is presented in the form of an alert to the end user or by automatically retraining the model based on the feedback data, training data, or some combination of the two data sets. Otherwise, the indication is not presented. Following the threshold determination, in block 440, the results are fed back into the learning model to optimize the weights and threshold value. The steps are repeated as new feedback data is received in order to determine the most efficient point to retrain the learning model.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A method for automated early anomaly detection in a continuous learning model comprising:
training a continuous learning model with a training data set of different records and a known target class for each of the different records;
deploying the continuous learning model in memory of a host server;
monitoring performance of the continuous learning model; and,
prior to receiving a complete feedback data set for the continuous learning model, computing a metric in the continuous learning model based upon unseen records in the continuous learning model that had not been present in the training data set, determining poor quality of the continuous learning model for a metric computed to exceed a threshold value and displaying a recommendation in the host server to retrain the continuous learning model responsive to the determination of poor quality of the continuous learning model.

2. The method of claim 1, wherein the metric is computed based upon a number of unseen records in the continuous learning model relative to a total number of records in the continuous learning model.

3. The method of claim 2, wherein the metric is computed based upon a number of unique ones of the unseen records in the continuous learning model relative to the number of unseen records in the continuous learning model relative to the total number of records in the continuous learning model.

4. The method of claim 3, wherein the metric is a combination of the number of unseen records in the continuous learning model relative to the total number of records in the continuous learning model and the number of unique ones of the unseen records in the continuous learning model relative to the number of unseen records in the continuous learning model.

5. The method of claim 4, wherein each of the number of unseen records in the continuous learning model relative to the total number of records in the continuous learning model, and the number of unique ones of the unseen records in the continuous learning model relative to the number of unseen records in the continuous learning model are weighted within the combination.

6. A data processing system configured for automated early anomaly detection in a continuous learning model, the system comprising:
a host computing system comprising memory and at least one processor;
fixed storage coupled to the host computing system; and,
an automated early anomaly detection module comprising computer program instructions executing in the memory of the host computing system that upon execution are adapted to perform:
training a continuous learning model with a training data set of different records and a known target class for each of the different records;
deploying the continuous learning model in the memory of the host computing system;
monitoring performance of the continuous learning model; and,
prior to receiving a complete feedback data set for the continuous learning model, computing a metric in the continuous learning model based upon unseen records in the continuous learning model that had not been present in the training data set, determining poor quality of the continuous learning model for a metric computed to exceed a threshold value and displaying a recommendation in the host server to retrain the continuous learning model responsive to the determination of poor quality of the continuous learning model.

7. The system of claim 6, wherein the metric is computed based upon a number of unseen records in the continuous learning model relative to a total number of records in the continuous learning model.

8. The system of claim 7, wherein the metric is computed based upon a number of unique ones of the unseen records in the continuous learning model relative to the number of unseen records in the continuous learning model relative to the total number of records in the continuous learning model.

9. The system of claim 8, wherein the metric is a combination of the number of unseen records in the continuous learning model relative to the total number of records in the continuous learning model and the number of unique ones of the unseen records in the continuous learning model relative to the number of unseen records in the continuous learning model.

10. The system of claim 9, wherein each of the number of unseen records in the continuous learning model relative to the total number of records in the continuous learning model, and the number of unique ones of the unseen records in the continuous learning model relative to the number of unseen records in the continuous learning model are weighted within the combination.

11. A computer program product for automated early anomaly detection in a continuous learning model, the computer program product comprising a computer readable storage medium having program instructions embodied therewith, wherein the computer readable storage medium is not a transitory signal per se, the program instructions executable by a device to cause the device to perform a method comprising:
training a continuous learning model with a training data set of different records and a known target class for each of the different records;
deploying the continuous learning model in memory of a host server;
monitoring performance of the continuous learning model; and,
prior to receiving a complete feedback data set for the continuous learning model, computing a metric in the continuous learning model based upon unseen records in the continuous learning model that had not been present in the training data set, determining poor quality of the continuous learning model for a metric computed to exceed a threshold value and displaying a recommendation in the host server to retrain the continuous learning model responsive to the determination of poor quality of the continuous learning model.

12. The computer program product of claim 11, wherein the metric is computed based upon a number of unseen records in the continuous learning model relative to a total number of records in the continuous learning model.

13. The computer program product of claim 12, wherein the metric is computed based upon a number of unique ones of the unseen records in the continuous learning model relative to the number of unseen records in the continuous learning model relative to the total number of records in the continuous learning model.

14. The computer program product of claim 13, wherein the metric is a combination of the number of unseen records in the continuous learning model relative to the total number of records in the continuous learning model and the number of unique ones of the unseen records in the continuous learning model relative to the number of unseen records in the continuous learning model.

15. The computer program product of claim 14, wherein each of the number of unseen records in the continuous learning model relative to the total number of records in the continuous learning model, and the number of unique ones of the unseen records in the continuous learning model relative to the number of unseen records in the continuous learning model are weighted within the combination.
